(19) United States
(12) Patent Application Publication
(10) Pub. No.: US 2008/0094225 A1
(43) Pub. Date: Apr. 24, 2008

(54) RFID Collar

(75) Inventors: Walter J. Frankewich, Maryville, TN (US); Tim Schoenfelder, Ankeny, IA (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/551,240

(22) Filed: Oct. 20, 2006

(51) Int. Cl. G08B 23/00

(52) U.S. Cl. 340/573.1; 340/572.1

(57) ABSTRACT

An RFID collar for tracking and locating animals, and method of manufacturing the same. The RFID collar includes an RFID tag substantially enclosed within an animal collar. In manufacture, a mold for defining a collar-shaped volume is provided. At least one support member is configured to engage an RFID tag and suspend the RFID tag within the volume, in preparation for the molding process that forms the collar. An amount of uncured collar material is forced by an injection molding apparatus into the mold, thereby substantially surrounding the RFID tag. Thereafter, the uncured collar material is cured.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a radio frequency identification (hereinafter an “RFID”) device for locating and tracking animals. More particularly, this invention pertains to an RFID device embedded within a molded animal collar.

2. Description of the Related Art

A radio frequency identification (RFID) system is a technology that uses radio waves to identify objects. An RFID system includes a digital memory chip attached to an antenna creating an RFID tag, and a reader for reading the RFID tag. The digital memory chip carries information used to identify the RFID tag. The reader transmits radio signals which are received by the RFID tag antenna, enabling the information on the RFID tag to be transmitted. The reader is then able to detect the information transmission from the RFID tag and determine the identity of the RFID tag. Additionally, some RFID systems allow the reader to determine the proximity of the RFID tag to the reader.

RFID systems are currently in use for recording the whereabouts of various items, such as merchandise, vehicles, and animals. In the field of RFID tracking systems for locating animals, an RFID tag carrying information identifying a specific animal is typically surgically embedded beneath the skin of the animal. A reader is then provided to determine the identification information stored on the RFID tag, and hence, the location and ownership of the animal.

Subdermal implantation of RFID tags poses several problems. The subdermal placement of the RFID tag requires selection of an RFID tag constructed from biologically inert materials. The time and expense associated with subdermal implantation of an RFID tag within an animal discourages use of an animal RFID tracking system. Moreover, many animal owners feel that a medically invasive procedure to embed an RFID in their animal is cruel. So, in an effort to minimize the invasiveness of the subdermal implantation procedure, subdermally implanted RFID tags are often designed to be quite small, thereby adding to the expense of manufacture of the RFID tag.

### BRIEF SUMMARY OF THE INVENTION

An RFID collar for tracking and locating animals, and method of manufacturing the same, is disclosed. The RFID collar includes an RFID tag substantially enclosed within an animal collar. The animal collar is fabricated from a molding material, such as an elastomer, polymer, or other plastic material. According to one embodiment of the present invention, a passive RFID tag is provided. Another embodiment provides an active RFID tag.

In manufacture, a collar mold for defining a collar-shaped volume is provided. At least one support member is configured to engage an RFID tag and suspend the RFID tag within the volume, in preparation for the molding process that forms the collar. After the RFID tag is positioned within the volume through engagement with the at least one support member, an amount of uncured collar material is forced by an injection molding apparatus into the collar mold. The uncured collar material substantially surrounds the RFID tag. Thereafter, the uncured collar material is cured, forming the collar within which the RFID tag is enclosed.

In one embodiment, a protective material is provided to protect the RFID tag from damage during and following the injection molding process. In manufacture, the protective material is applied to the RFID tag at a point prior to the injection of the uncured collar material. The protective material is disposed to substantially surround and enclose the RFID tag.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of an RFID collar constructed in accordance with several features of the present invention;

FIG. 2 is a block diagram showing one embodiment of the RFID tag;

FIG. 3 is a block diagram showing another embodiment of the RFID tag;

FIG. 4 is a perspective view of a mold suitable for use in manufacturing the RFID collar of the present invention, showing the RFID tag in exploded view;

FIG. 5 is a perspective view of the mold of FIG. 4, showing the RFID tag in place in the mold and uncured collar material being forced into the mold;

FIG. 6 is a perspective view of an RFID collar constructed using the mold of FIGS. 4 and 5;

FIG. 7 is a perspective view of another embodiment of a mold suitable for use in manufacturing the RFID collar of the present invention, showing the RFID tag in exploded view;

FIG. 8 is a perspective view of the mold of FIG. 7, showing the RFID tag in place in the mold and uncured collar material being forced into the mold;

FIG. 9 is a perspective view of an RFID collar constructed using the mold of FIGS. 7 and 8;

FIG. 10 is a cross-sectional view of another embodiment of the RFID collar, showing the protective material surrounding the RFID tag.

### DETAILED DESCRIPTION OF THE INVENTION

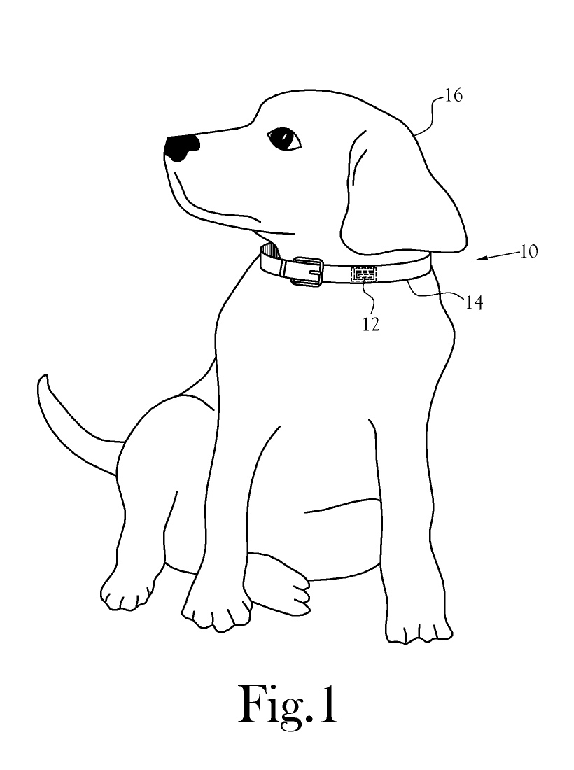

An RFID collar for tracking and locating animals, and method of manufacturing the same, is disclosed. FIG. 1 depicts an animal 16 wearing one embodiment of an RFID collar 10, including an RFID tag 12 substantially enclosed within an animal collar 14. As set forth in greater detail below, the animal collar 14 is fabricated from a molding material, such as an elastomer, polymer, or other plastic material. The animal collar 14 is adapted to secure to the animal, thereby allowing the RFID tag 12 to be carried by the animal.

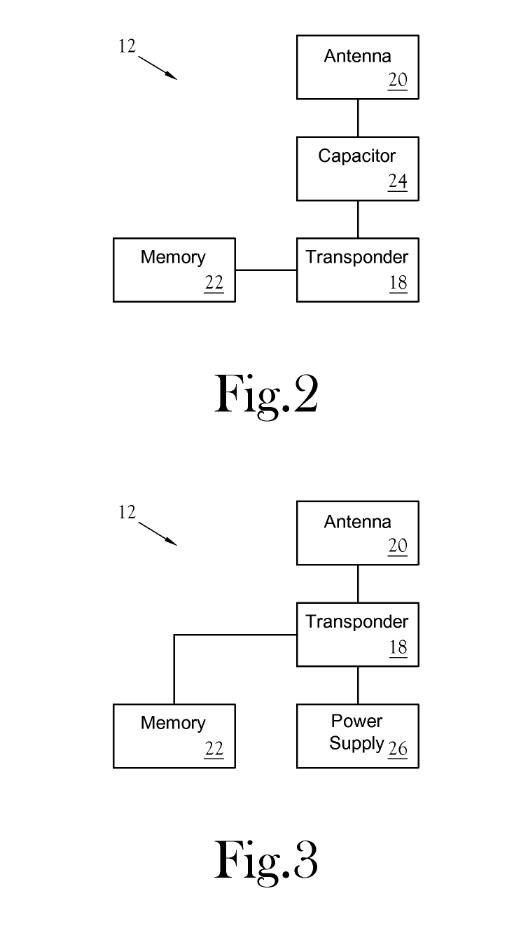

FIG. 2 is a block diagram of one embodiment of a passive RFID tag 12. The RFID tag 12 includes a transponder 18, which includes an antenna 20, a capacitor 24, and a memory 22. The antenna 20 is adapted to receive and transmit radio frequency signals. The capacitor 24 is configured to induce an electrical current when the antenna 20 receives a radio frequency signal of a desired wavelength. The power generated is minimal and is typically sufficient for a brief transmission, such as an identifier that is stored in the memory 22.

Absent an initial receipt of a radio frequency signal of the desired wavelength, the RFID tag 12 of the embodiment of FIG. 2 remains at rest. Upon receipt by the antenna 20 of a radio frequency signal of the desired wavelength, the capacitor 24 induces and supplies electrical current to the transponder 18. When electrical current is supplied to the transponder 18, the transponder 18 causes the antenna 20 to transmit a radio signal communicating the identifier stored in the memory 22.

From the foregoing description, it will be recognized by those skilled in the art that a passive RFID tag 12 is depicted in FIG. 2. FIG. 3 is a block diagram of another embodiment of the RFID tag 12, known as an active RFID tag. In this embodiment, the RFID tag 12 is connected to a power supply 26. The power supply 26 is configured to supply electrical current to the transponder 18. In this configuration, the RFID tag 12 is adapted to continually transmit a radio signal communicating the identifier stored in the memory 22. In one embodiment, the RFID tag 12 includes a built-in power supply 26. In another embodiment, the RFID tag 12 is wired to a remote power supply 26 located external to the RFID tag 12.

Both active and passive RFID tags are suitable for use with the present invention. Active RFID tags, such as the RFID tag illustrated in FIG. 3, generally have a longer range than passive RFID tags. However, active RFID tags are larger than their passive counterparts, due to the inclusion of the power supply 26. In the embodiment of FIG. 3, the power supply 26 is a battery. However, those skilled in the art will recognize that other power sources can be used to accomplish the power supply 26 without departing from the spirit and scope of the present invention. Passive RFID tags, such as the RFID tag illustrated in FIG. 2, are typically small and do not require periodic maintenance, such as battery replacement. Also, it is understood by one skilled in the art that the RFID tags may be constructed such as to exhibit varying degrees of rigidity, from very rigid to flexible. To this extent, a flexible RFID tag is contemplated to allow flexure of the collar about the RFID tag. As well, a substantially rigid RFID tag is contemplated to provide durability to the RFID tag components.

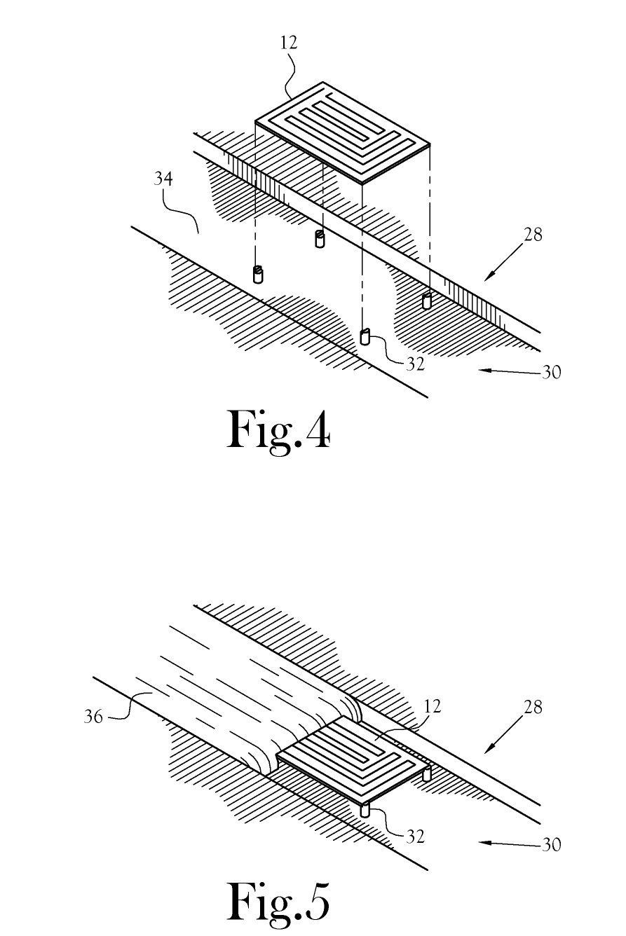

FIGS. 4 and 5 relate to the first method presented herein for manufacturing the RFID collar 10. In FIG. 4, a collar mold 28 for defining a collar-shaped volume 30 is provided. It is important to note that only a portion of the collar mold 28 is shown in FIG. 4. The collar mold 28 defines at least one support member 32 adapted to engage the RFID tag 12 and configured to suspend an RFID tag 12 within the volume 30, in preparation for the molding process that forms the collar 14. The RFID tag 12 is placed in the collar mold 28 and is supported by the support members 32. In the illustrated embodiment, the at least one support member 32 secures the RFID tag 12 against movement within the collar mold 28 during the molding process. In another embodiment, the at least one support member 32 merely supports the RFID tag 12 away from a collar mold lower surface 34. Those skilled in the art will recognize that the at least one support member 32 may be configured to provide varying degrees of support for the RFID tag 12 within the volume 30 without departing from the spirit and scope of the present invention.

FIG. 5 is a partial perspective view of the collar mold 28 of FIG. 4, showing the forming of the collar 14. After the RFID tag 12 is positioned within the volume 30 through engagement with the at least one support member 32, an amount of uncured collar material 36 is forced by an injection molding apparatus into the collar mold 28. The uncured collar material 36 substantially surrounds the RFID tag 12. Thereafter, the uncured collar material 36 is cured, forming the collar 14 within which the RFID tag 12 is enclosed.

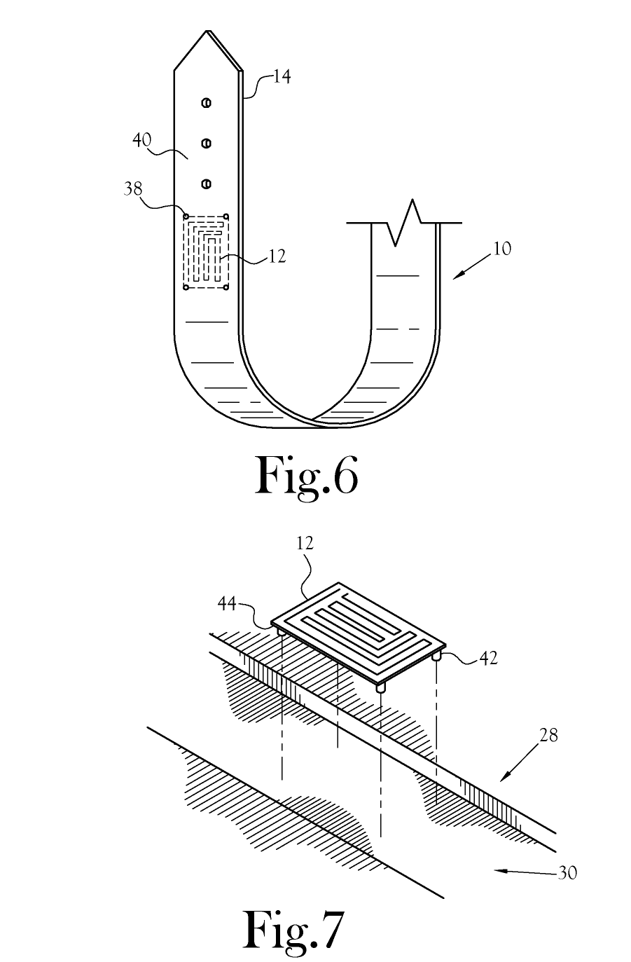

FIG. 6 illustrates a partial view of an embodiment of the RFID collar 10, manufactured using the collar mold 28 of FIGS. 4 and 5. As shown in FIG. 6, one surface 40 of the collar 14 defines at least one cavity 38 having a shape complementary to each of the at least one support members 32. The at least one cavity 38 forms as a result of the at least one support member 32 preventing complete encapsulation of the RFID tag 12 by the uncured collar material 36. In use, the cavity surface 40 of the collar 14 is typically selected to be the interior surface of the collar 14. In this configuration, the cavity surface 40 is adjacent to the surface of the animal, and the at least one cavity 38 is thereby more protected against intrusion of water or other substances to the RFID tag 12. Of course, it will be understood that configuration of the cavity surface 40 of the collar 14 as the interior surface is not necessary to accomplish the present invention.

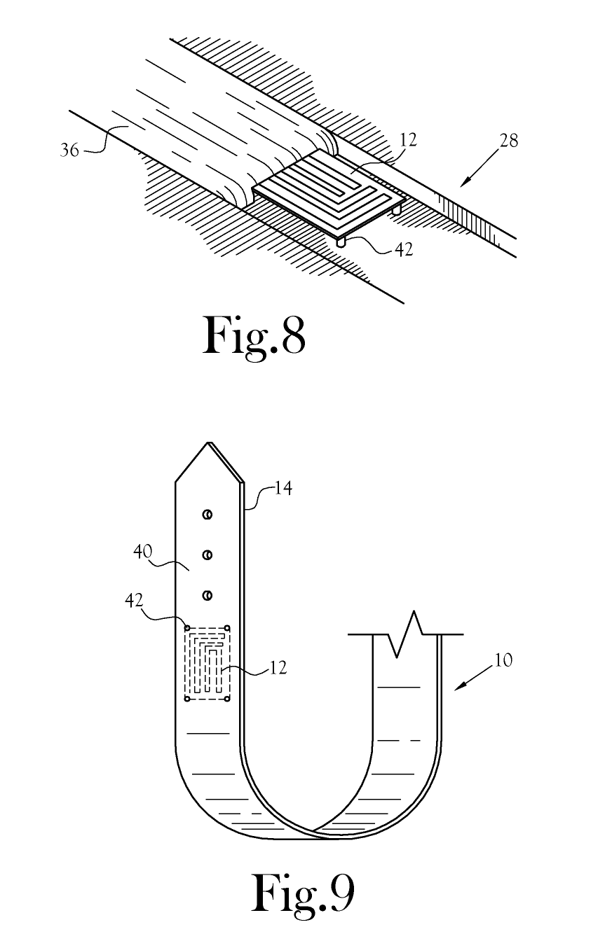

FIGS. 7 and 8 relate to the second method presented herein for manufacturing the RFID collar 10. In this method and with reference to FIG. 7, the RFID tag 12 includes at least one placeholder 42 configured to support the RFID tag 12 above a surface. In the illustrated embodiment, the at least one placeholder 42 is connected to a bottom surface 44 of the RFID tag 12. However, it will be appreciated that such connection is not necessary to accomplish the present invention. To this extent, the RFID tag 12 may simply be adapted to rest upon the at least one placeholder 42 to allow the at least one placeholder 42 to support the RFID tag 12 from a surface.

FIG. 8 is a partial perspective view of the RFID tag 12 of FIG. 7 placed into a collar mold 28, showing the forming of the collar 14. As shown in FIG. 8, the RFID tag 12 with the at least one placeholder 42 is placed in the collar mold 28 such that the at least one placeholder 42 supports the RFID tag 12 within the volume 30. After the RFID tag 12 is positioned within the volume 30, an amount of uncured collar material 36 is forced by an injection molding apparatus into the collar mold 28. The uncured collar material 36 substantially surrounds the RFID tag 12. Thereafter, the uncured collar material 36 is cured, forming the collar 14 within which the RFID tag 12 is enclosed.

FIG. 9 illustrates a partial view of an embodiment of the RFID collar 10, manufactured using the method of FIGS. 7 and 8. As shown in FIG. 9, the placeholders 42 substantially mesh with the collar 14 to completely encapsulate the RFID tag 12. Thus, this method allows formation of an RFID collar 10 lacking the cavities 38 of the embodiment of FIGS. 4 and 5.

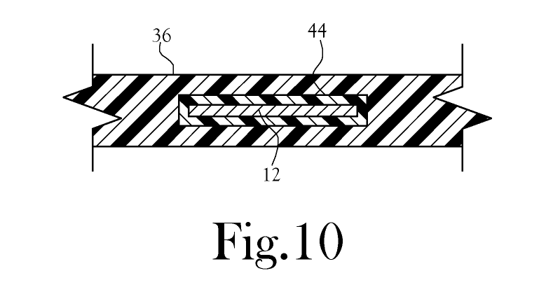

FIG. 10 is a cross-sectional view of another embodiment of the RFID collar 10. In this embodiment, a protective material 44 is provided to protect the RFID tag 12 from damage during and following the injection molding process. The protective material 44 is disposed to substantially surround and enclose the RFID tag 12. In the illustrated embodiment, the protective material 44 is a thermal barrier material, such as Glastherm®, Thermalate®, or Pyropel®. In another embodiment, the protective material 44 is a rigid material, such as a ceramic, plastic, or other rigid material, thereby providing structural support to the RFID tag 12. In yet another embodiment, the protective material 44 is a material impermeable to liquid. In this embodiment, the protective material 44 serves to provide waterproofing to the RFID tag 12 during use. Those skilled in the art will recognize other materials which are suitable for use as the protective material 44 and which provide varying forms of protection to the RFID tag 12. Such other materials may be used as the protective material 44 without departing from the spirit and scope of the present invention. As well, it will be understood that the RFID tag 12 can be constructed to include a waterproof substrate, which can be configured between the RFID tag 12 and the at least one cavity 38 to protect against intrusion of water or other substances to the RFID tag 12

In manufacture, the protective material 44 is applied to the RFID tag 12 at a point prior to the injection of the uncured collar material 36. The particular method of application of the protective material 44 depends upon the type of material selected to accomplish the protective material 44 of the present embodiment. To this extent, those skilled in the art will recognize numerous methods by which the protective material 44 may be applied.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A method of manufacturing an animal collar having an RFID device, said method comprising the steps of:
providing a mold defining a volume for forming an animal collar;
placing an RFID device into the mold, the RFID device having at least a transponder including an antenna, and a memory, the RFID device being adapted to receive a first radio frequency signal and transmit a second radio frequency signal in response to such receipt; and
forcing a collar material into the mold;
whereby an animal collar containing an RFID device is formed.

2. The method of claim 1 further comprising the step of substantially encasing the RFID device in a protective material.

3. The method of claim 2 wherein the protective material is a thermal barrier material.

4. The method of claim 2 wherein the protective material is a waterproofing material.

5. The method of claim 1 further comprising the step of programming an identifier into the memory, whereby the RFID is adapted to communicate the identifier within the second radio frequency signal.

6. The method of claim 1, wherein the RFID device further has a power supply configured to provide power to the transponder.

7. The method of claim 1, wherein the RFID device further has a capacitor configured to provide power to the transponder when the RFID device receives a radio frequency signal of a desired wavelength.

8. The method of claim 1 wherein said step of placing an RFID device into the mold includes supporting the RFID device within the volume.

9. The method of claim 8, wherein said step of supporting the RFID device within the volume includes:
placing at least one support structure into the mold; and
placing the RFID device onto the at least one support structure.

10. The method of claim 8, wherein said step of providing a mold defining a volume for forming an animal collar includes selecting a mold providing at least one support structure adapted to support the RFID device within the volume; and
wherein said step of supporting the RFID device within the volume includes placing the RFID device onto the at least one support structure within the mold.

11. The method of claim 8, wherein said step of supporting the RFID device within the volume includes:
securing at least one support structure to the RFID device such that the at least one support structure is adapted to support the RFID device within the volume; and
placing the RFID with the at least one support structure device into the mold.

12. The method of claim 1 wherein said step of forcing a collar material into the mold includes:
forcing an uncured collar material into the mold; and
curing the collar material.

13. An animal collar manufactured by a process comprising the steps of:
providing a mold defining a volume for forming an animal collar;
placing an RFID device into the mold, the RFID device having at least a transponder including an antenna, and a memory, the RFID device being adapted to receive a first radio frequency signal and transmit a second radio frequency signal in response to such receipt; and
substantially filling the mold with a moldable material.

14. The animal collar of claim 13, said manufacturing process further comprising the step of substantially encasing the RFID device in a protective material.

15. The animal collar of claim 14 wherein the protective material is a thermal barrier material.

16. The animal collar of claim 14 wherein the protective material is a waterproofing material.

17. The animal collar of claim 13, said manufacturing process further comprising the step of programming an identifier into the memory, whereby the RFID is adapted to communicate the identifier within the second radio frequency signal.

18. The animal collar of claim 13, wherein the RFID device further has a power supply configured to provide power to the transponder.

19. The animal collar of claim 13, wherein the RFID device further has a capacitor configured to provide power to the transponder when the RFID device receives a radio frequency signal of a desired wavelength.

20. The animal collar of claim 13, wherein said manufacturing step of placing an RFID device into the mold includes supporting the RFID device within the volume.

21. The animal collar of claim 20, wherein said manufacturing step of supporting the RFID device within the volume includes:
placing at least one support structure into the mold; and
placing the RFID device onto the at least one support structure.

22. The animal collar of claim 20, wherein said manufacturing step of providing a mold defining a volume for forming an animal collar includes selecting a mold providing at least one support structure adapted to support the RFID device within the volume; and
wherein said manufacturing step of supporting the RFID device within the volume includes placing the RFID device onto the at least one support structure within the mold.

23. The animal collar of claim 20, wherein said manufacturing step of supporting the RFID device within the volume includes:
securing at least one support structure to the RFID device such that the at least one support structure is adapted to support the RFID device within the volume; and
placing the RFID with the at least one support structure device into the mold.

24. The animal collar of claim 13 wherein said manufacturing step of substantially filling the mold with moldable material includes:
substantially filling the mold with an uncured moldable material; and
curing the moldable material.

25. A collar apparatus for use with an animal, said collar apparatus comprising:
an RFID tag including a transponder for broadcasting an identification code;
a collar internally carrying said RFID tag, said collar sized and shaped to be secured about a portion of the animal thereby allowing the animal to carry said collar apparatus, said collar being flexible and substantially watertight.

26. The collar apparatus of claim 25 wherein said collar substantially encapsulates said RFID tag.

27. The animal collar of claim 25, wherein said RFID tag is connected to a power supply, said power supply being configured to provide power to the transponder.

28. The animal collar of claim 27, wherein said power supply is included in said RFID tag.

29. The animal collar of claim 27, wherein said power supply is remotely wired to said RFID tag.

30. The animal collar of claim 25 further including a protective material disposed between said RFID tag and said collar.

31. The animal collar of claim 30, wherein said protective material is configured to substantially encapsulate said RFID tag.

32. The animal collar of claim 30, wherein said protective material is a thermal barrier material.

33. The animal collar of claim 30, wherein said protective material is a waterproofing material.
